(19) United States
(12) Patent Application Publication
(10) Pub. No.: US 2012/0188417 A1
(43) Pub. Date: Jul. 26, 2012

(54) METHOD AND SYSTEM FOR DETECTING LENS DISTORTIONS

(76) Inventor: Marco Winter, Hannover (DE)

(21) Appl. No.: 13/355,821

(22) Filed: Jan. 23, 2012

(30) Foreign Application Priority Data
Jan. 24, 2011 (EP) 11305067.8

(51) Int. Cl. H04N 5/217

(52) U.S. Cl. 348/241; 348/E05.078

(57) ABSTRACT

A method for determining optical distortions of a video recording unit is provided. The method includes positioning and orienting a light source such 5 that it directs a light plane to hit a non-flat scenery generating a bright shape thereon. The method also includes modulating, with a first frequency, the orientation of the light source, such that the bright shape periodically sweeps over the scenery in a sweeping direction non-parallel to a direction of main extension of the bright 10 shape. Further, the method includes modulating, with a second frequency different from the first frequency, the position of the light source relative to the video recording unit in the sweeping direction, and recording, with the video recording unit and while the orientation and the position of the light source are being modulated, sequences of images capturing at least parts of the bright 15 shape.

### TECHNICAL FIELD

The present invention relates to the field of optical systems. In particular, exemplary embodiments of the present invention relate to a method and system for detecting lens distortions in cameras.

### BACKGROUND OF THE INVENTION

The optical elements used by cameras and other optical devices to collect images from the environment often introduce errors into the images. Such errors may include various aberrations that distort the color or perspective of the images. Such errors may be perceptible to a viewer and, thus, may decrease the accuracy or aesthetic value of the images.

Various systems have been implemented to detect these distortions in image collection systems, so that such distortions could be corrected by appropriate processing. Generally, image aberration detection may take place prior to the collection of the images, by modification of the design of the optical elements, or after image collection, through processing of stored images in a computer system. For example, in a process of characterizing an optical system, a user may acquire images of a particular object, typically a board having specific patterns, such as a checker board, whose images can be analyzed for identifying distortions produced by the optical systems. In so doing, images of the patterned board can be repeatedly analyzed by a user and/or computers using various mathematical algorithms for detecting and correcting non-uniformities and/or anomalies arising from the lens distortions.

Although such methods are well known and are in prevalent use, nevertheless these and other similar methods suffer from several shortcomings. For instance, they require that the imaged board itself be perfectly shaped and patterned with no inherent distortions of its own, as those may give rise to additional image distortions otherwise not detectable and/or correctable by the algorithms used for analyzing the images. In addition, for achieving proper analysis, the type and/or size of the board is typically chosen in accordance with the optical system at hand. This yet, may further complicate the image analysis as it requires preparation and prior knowledge of the optical system used, as well as requiring a multitude of boards for accommodating the various types of optical systems. Still further, because the image analysis generally requires the board to encompass the entire field of view, such boards may be typically too large for handling and/or inconvenient for transfer.

A publication in the Proceeding of the Third International Symposium on 3D Data Processing, Visualization, and Transmission, 0-7695-2825-2/06, to Furukawa et al., entitled “Self-calibration of Multiple Laser Planes for 3D Scene Reconstruction,” purports to disclose a self-calibrating active vision system using line lasers and a camera. The reference further purports to disclose defining an estimation of multiple laser planes from curves produced by laser reflections as observed from a sequence of images captured by the camera. The method further comprises computing approximated solutions of the equations by using Grobner bases. Also provided is a 3D measurement system for using the above proposed method. The system includes of laser projector with two line lasers and a single camera. In implementing the above method, the projector can be moved freely so that the projected lines sweep across the surface of the scene to achieve a 3D shape.

A improved method and system for detecting lens distortions is desirable.

### BRIEF SUMMARY OF THE INVENTION

A method for determining optical distortions of an optical system is set forth in claim 1. This method includes positioning and orienting a light source such that it directs a light plane to hit a non-flat scenery generating a bright shape thereon. The method further comprises modulating, with a first frequency, the orientation of the light source, such that the bright shape periodically sweeps over the scenery in a sweeping direction non-parallel to a direction of main extension of the bright shape. In addition, the method includes modulating, with a second frequency different from the first frequency; the position of the light source relative to the video recording unit in the sweeping direction. Further, the method includes recording, with the video recording unit and while the orientation and the position of the light source are being modulated, sequences of images capturing at least parts of the bright shape. The method further includes selecting, from the sequences of images, those images as selected images in which the bright shape is captured as a continuous line, and utilizing the selected images to determine the optical distortions of the video recording unit.

Embodiments of the present invention also provide a system for determining optical distortions of a video recording unit. The system includes a light source, arranged at a first distance from a non-flat scenery. The light source is adapted for generating a light plane hitting the scenery and generating a bright shape thereon. The system further includes a video recording unit, arranged at a second distance from the scenery different from the first distance, and capturing the scenery and at least part of the bright shape. Further, the system includes means for modulating, with a first frequency, the orientation of the light source such that the bright shape periodically sweeps over the scenery in a sweeping direction non-parallel to a direction of main extension of the bright shape. The system also includes means for modulating, with a second frequency different from the first frequency, the position of the light source relative to the video recording unit in the sweeping direction. The included video recording unit is equipped and configured to record, while the orientation and the position of the light source are being modulated, sequences of images such that the recording unit captures at least parts of the bright shape. The system is further equipped and configured to utilize, for the determining of optical distortions, those of the images where the bright shape is captured as a continuous line.

A preferred embodiment of the present invention is described with reference to the accompanying drawings. The preferred embodiment merely exemplifies the invention. Plural possible modifications are apparent to the skilled person. The gist and scope of the present invention is defined in the appended claims of the present application.

### BRIEF DESCRIPTION OF THE DRAWINGS

FIG. 1 is a diagram that is useful in explaining lens distortions.

FIG. 2 is a perspective view of an optical system, in accordance with an embodiment of the present invention.

FIG. 3A is a top view of an optical system, in accordance with an embodiment of the present invention.

FIG. 3B is a side view of another optical system, in accordance with an embodiment of the present invention.

FIG. 4 illustrates images acquired by an optical system, in accordance with an exemplary embodiment of the present invention.

FIG. 5 illustrates an image resulting from a collection of superimposed images, in accordance with the present invention.

FIG. 6 is a block diagram of a process flow, in accordance with the present invention.

### DETAILED DESCRIPTION OF THE INVENTION

Disclosed embodiments of the present technique relate to methods and systems for detecting lens distortions of an optical system, such as a camera or multiple cameras each having one or more lens elements. The disclosed method and system provide for an optical set up where a camera, such as a digital camera, and its lens elements are disposed in front of a grid and a background. In a preferred embodiment, the grid is disposed in front of the background. In accordance the present technique, a laser, generally disposed near the lens element of the camera, is configured for emitting beams of light across the grid and background. While laser projects the light, the laser may also rotate about an axis generally transverse to the axis of the optical system. In one preferred embodiment, the laser rotates about an axis approximately orthogonal to the axis of the optical system. In addition, the laser may be moved a long a vertical direction as defined by the optical system. In so doing, the laser sweeps across the grid and background to produce sets of line images, subsequently captured by the camera. As will be described further below, analysis of the acquired images may lead to selecting a subset of such images having particular features and satisfying certain criteria, thereby further facilitating the identification of distortions produced by the lens of optical system. Further, the selected images may be compiled and/or superimposed, i.e., stacked on top of the other, for displaying and amplifying distortion and/or other image artifacts otherwise present in the acquired images.

Hence, the disclosed method and system for detecting lens distortions can be carried out with relative ease using simple and relatively inexpensive materials, while achieving high accuracy. Moreover, the technical effect of the invention provides a highly versatile and feasible lens-distortion detection system, self adjustable and usable with a large variety of optical systems.

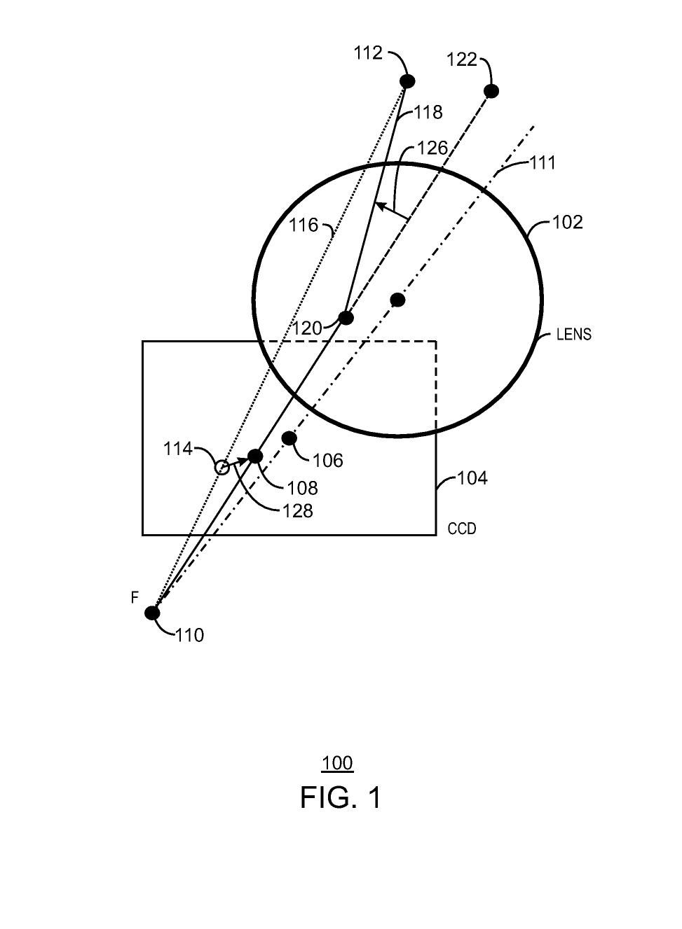

FIG. 1 is a diagram that is useful in explaining lens distortions. The figure includes a simple optical setup adapted mainly for exemplifying an optical distortion whose features and attributes are detectable by the methods and systems described below. While the figure may depict a certain type of optical distortion, those skilled in the art will appreciate that the below embodiments may be adapted for detecting optical distortions of various kinds, such as the optical distortions illustrated in FIG. 1 and variants thereof.

Accordingly, FIG. 1 depicts a perspective view of an optical system 100 including a lens 102 disposed in front of an imaging device, particularly, a charged coupled device 104, which may be abbreviated as CCD herein. The device 104 is an imaging device typically included in digital cameras. For illustrative simplicity, a camera body and/or other components generally disposed near and/or surrounding vicinity of the CCD 104 are not illustrated by FIG. 1. Further, the CCD 104 is an electro-optical device adapted for converting light signals into electrical signals, which ultimately form and render an acquired image. Hence, the CCD 104 is made of multiple electro-optical elements, also termed pixels, whose structure and functionality make up an entire plane on which a digital image can be formed. In FIG. 1, exemplary pixels of the CCD 104 are labeled by reference numerals 106 and 108. A focal point 110 of the optical system is also illustrated as being disposed behind the CCD 104. As is well known, the focal point 110 may be considered as a point to which all light rays converge from a distance far away from the optical system 100. In addition, the lens 102, the CCD 104 and the focal point 110 are all disposed along an optical/camera axis 111, as illustrated.

FIG. 1 further illustrates a real point 112, such as one in scenery, captured by a field of view imaged by the optical system 100. While the point 112 generally forms a real object extending in three-dimensional of space, the image of the point 112, as acquired by the optical system 100, forms a two dimensional projection, i.e., image, viewable on a flat surface, screen and so forth. Hence, for an optical system suffering from no lens or other types of distortions, the point 112 would ideally be imaged by pixel 114 of the CCD 104. This is illustrated by line 116 traced back from the point 112 to the focal point 110 of the optical system 100. However, because lenses, such as the lens 102, generally attain inherent imperfections in their structure and/or composition, the lights rays refracted by the lens 102 may converge on the CCD 104 in a manner that skews or otherwise distorts the image of the viewable object.

For example, when imaging the real point 112, the optical distortions associated with the lens 102 can manifest when light ray 118 becomes overly skewed, as indicated by point 120 where the light impinges the lens 102. Thus, instead of being imaged at pixel 114 of the CCD 104, the point 112 may actually be imaged at the pixel 108. Consequently, for a viewer viewing the image, i.e., the real point 112, captured by the optical system 100, the point 112 may actually appear to be located at a point 122, as illustrated by line 124 traced back from the point 122 to the focal point 110. Such spatial distortion between the points 112 and 122 is further denoted by arrow 126, denoting an angular separation exiting between the aforementioned lines.

Optical distortions such as those described above can further be quantified on the surface on which the image is acquired and/or is viewed. This can be done by defining certain geometrical objects, such as shift vectors. A shift vector normally extends between pixels/points on the CCD 104 corresponding to those locations on the image on which light would have fallen had there been no optical distortions, and those points on the image where the actual light forms. Accordingly, in the illustrated embodiment, a shift vector 128 defines the spatial shift on the CCD 104 between the pixels 114 and the pixel 108 where the actual image falls on the CCD 104. The spatial shift may be representative of where the image would have appeared had there been no distortion. As one of ordinary skill may appreciate, the use of shift vectors in image analysis is advantageous in that such quantities can be typically obtained during image processing, that is, after the image is acquired. In so doing, the image analysis and the ensuing correction of the image can generally be performed without having to actually physically access and/or adjust the optical elements of the image acquisition system. Indeed, the availability of increasingly powerful microprocessors of ever decreasing size has made the use of post-collection processing to detect image distortions practical within image collection systems.

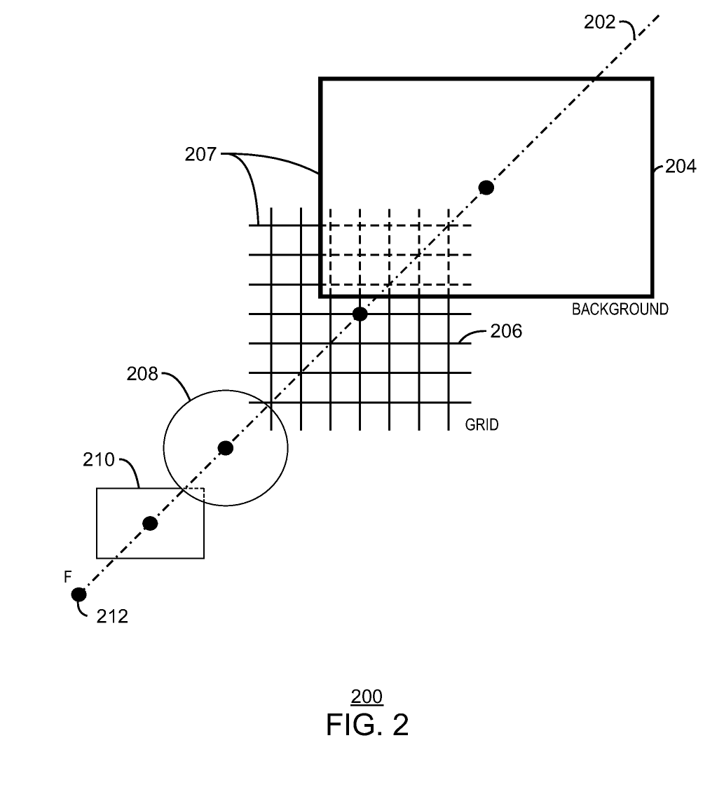

FIG. 2 is a perspective view of an optical system 200, in accordance with an embodiment of the present invention. The optical system 200 includes an optical/camera axis 202, having a background 204 and a grid 206 disposed about the axis 202. The background 204 and the grid 206 may collectively be referred herein as to scenery 207. The scenery 207 is generally considered to be non-flat, and adapted to receive a light place, for example, generated by laser light, for generating a bright shape on the scenery 207. The optical system 200 also includes a lens 208 and a CCD 210, both of which are also centered about the optical axis 202. Again, the lens 208 and the CCD 210 form components of a camera whose additional elements and components are omitted from the FIG. 2, so as to conveniently illustrate the relative position of the imaging elements of the camera relative to other elements of the optical system 200. Further, the background 204 may include a white uniform board, a white screen, or a wall. As will be described further below, the background 204 is adapted for receiving a laser light, where the laser light is adapted to be projected on the screen so that it can be clearly seen and imaged by the optical system 200. Hence, the background 204 should preferably be disposed at a distance enabling the camera, i.e., lens 208 and CCD 210, to capture the field of view in which the entire the entire background 204 is included.

As further illustrated, the grid 206 may form a square matrix formed, for example, out of a wire mesh or other similar material. The grid 206 may generally be disposed in front of and relatively close to the background 204. Accordingly, the grid 206 may be placed between the camera, i.e., the lens 208, the CCD 210, and/or the background 204 so that the grid 206, too, covers the entire field of view of the camera. Similar to the background 204, the grid 206 is also adapted for receiving the laser light such that when viewed the laser light appears as spots when the laser impinges the grid 206. As will be described further below, the camera, i.e., the lens 208 and CCD 210, are adapted for acquiring images of the laser light as it is projected across the background and grid, i.e., elements 204 and 206, respectively. As shown further below, such images may further be analyzed and/or processed to obtain information relating to the lens distortion of the optical system 200.

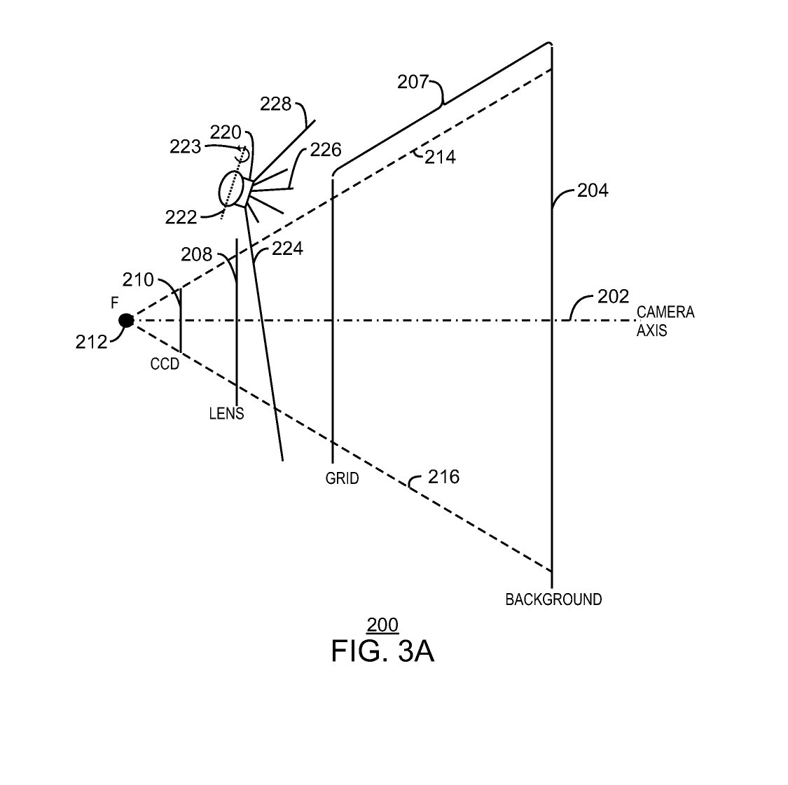

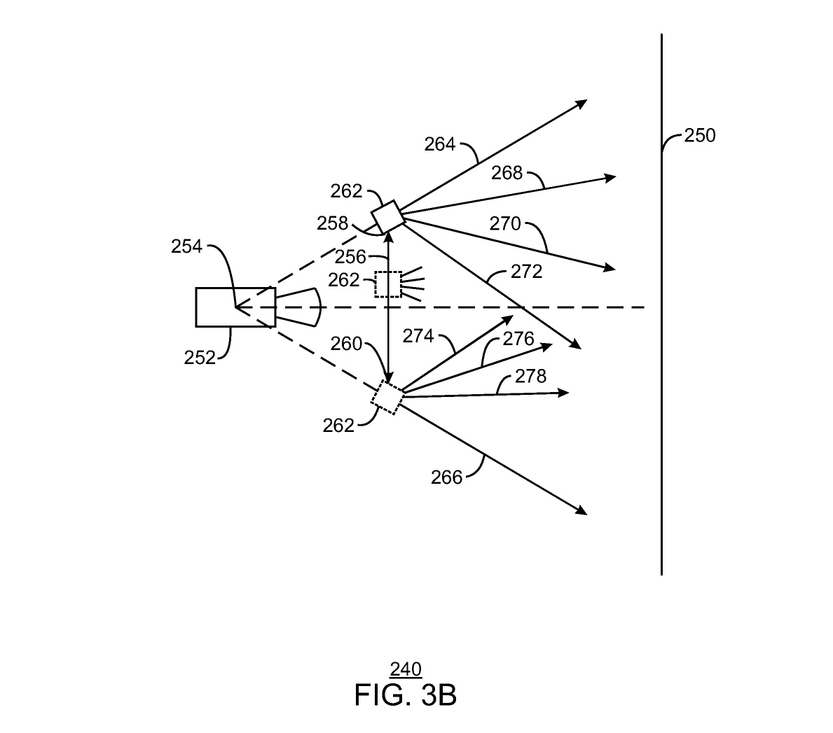

FIG. 3A is a top view of the optical system 200, in accordance with an embodiment of the present invention. As illustrated by the figure, lines 214 and 216, traced from the edges of the background 204 through the grid 206 and lens 208 and finally converging at the focal point 212, denote the field of view captured by the optical system 200. Further, the illustrated embodiment of the optical system 200 depicts a laser 220 positioned to the side and in close proximity to the lens 208. The laser 220 is positioned relative to the components of the optical system 200 such that it can rotate about an axis 222, as indicated by arrow 223. The axis 223 may be positioned so that it is generally transverse relative the camera axis 202. In a preferred embodiment, the axis 223 is made approximately parallel to the camera axis 202, however, other positioning configurations of the axis 223 relative to the optical system 200 may be envisioned.

Generally, the laser 220 may be adapted to generate a beam including a light plane, such as but not limited to having a fan shape. The laser 220 may include an ordinary laser, readily accessible for convenient multi-purpose use. Hence, the laser 220 may emit red, blue, green or other types of colored light, providing enough brightness to be viewable across the non-flat scenery, i.e., background 204 and grid 206. Accordingly, the light plane is projected across the scenery 207 to create a bright shape. Further, the laser 220 may be configured to be positioned and secured to a rotating a surface, such as a rotatable laser mount, table, and the like, used for rotating the laser about the axis 222 for projecting the laser light across the grid and background.

Hence, the laser 220 is adapted to rotate in the direction indicated by the arrow 223. In so doing, the laser sweeps a light plane, as indicated by lines 224, 226 and 228, across the background 204 and grid 206. As shown below, this type of movement ensures the laser light lines 224-228 formed by the rotating light plane are projected across the background to produces slim straight lines clearly viewable across the background and grind. It should be borne in mind that rotating movement of the laser 220 can generally considered as a modulation, with a first frequency, of the of the orientation of the laser such that the bright shape formed across the scenery 207 periodically sweeps over the scenery in a sweeping direction, non-parallel to a direction of main extension of bright shape.

In addition to having an ability to rotate about the axis 222, the laser 220 may also posses additional degrees of freedom for movement about and/or along additional axes disposed relative to the optical system 200. Accordingly, FIG. 3B illustrates is a side view of another optical system, in accordance with an exemplary embodiment of the present technique. FIG. 3B shows elements similar to those shown in FIG. 3A. Generally, FIG. 3B illustrates an optical system 240 with scenery 250 that may include a background and/or a grid, and a camera 252 having a focal point 254. FIG. 3B further illustrates a vertical axis, as indicated by 256 disposed between the scenery 250 and the camera 252. The line 256 includes end points 258 and 260, providing points in space bounding movement of a light source 262, such as a laser. As illustrated, to further facilitate the projection of lines and spots across the scenery 250, the laser 220 moves between the points 258 and 260 to sweep a light plane bounded by the arrow lines 264 and 266. In addition, the laser 262 also sweeps the light plane in a circular-type motion, as discussed above with reference to FIG. 3A and as illustrated by arrow lines 268-278. In so doing, the projection of the laser beam transitions between the lower and upper portions of the light plane boundaries 264 and 262, sweeping its beam for producing a bright shape across the scenery 250. The linear motion attained by the laser 263 along the axis 256 of the laser 220 may be independent of its rotational movement about the axis 222 shown in FIG. 3A. Further, the motion of the light source 262 along the axis 264 can be performed so as to constitute a second modulation of the light source 262 with a second frequency different from the above-mentioned first frequency associated with the rotational movement of the light source 262. The above mentioned two types of motions attained by the light source 262 are associated with two distinct frequencies for producing images across the scenery from which a subset is selected for further analysis for detecting optical distortions within the above optical set up. The two distinct frequencies used are preferably non-integer multiple of each other for achieving optimal results. It should further be borne in mind that the light source the laser 264 may be adapted to have additional degrees of freedom for translational, rotational and/or other types of movement, some of which may not be illustrated herein but are nonetheless achievable for producing the desired projections of the laser light across the scenery 250.

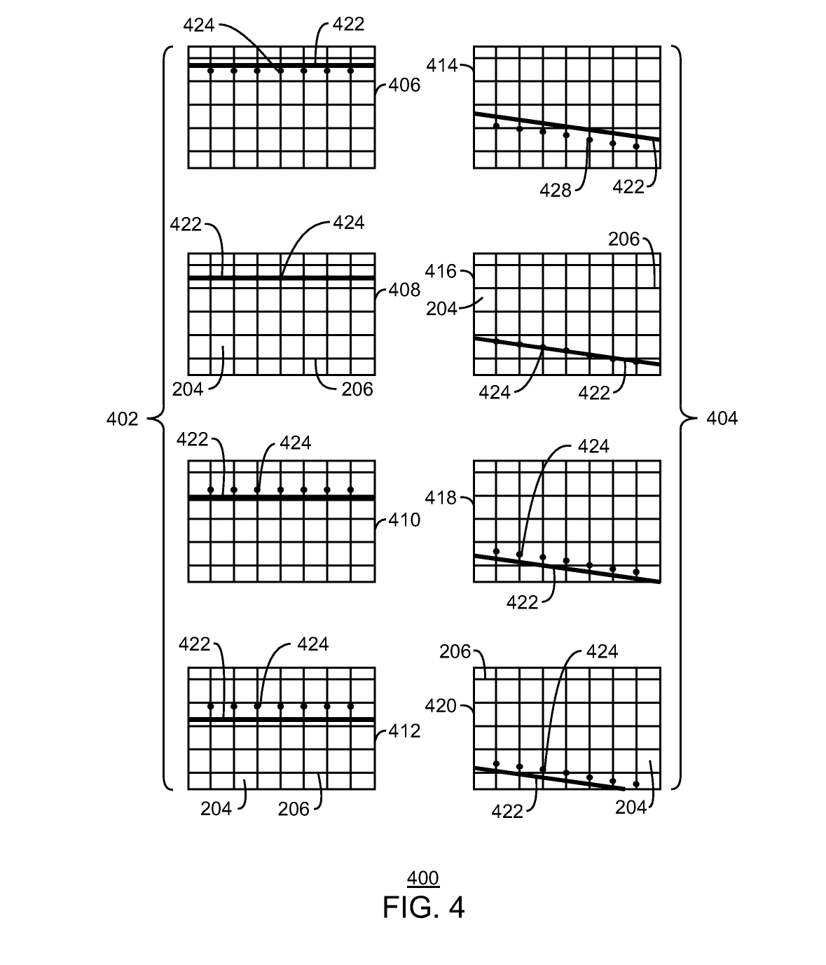

In accordance with exemplary embodiments of the present invention, the camera 252 is configured for recording with a video recording unit sequences of images of the bright shape formed across the scenery 250 while the orientation and the position of the light source are being modulated. Accordingly, FIG. 4 shows a collection 400 of images acquired by a camera, in accordance with an exemplary embodiment of the present invention. Generally, the collection of images 400 may be spilt into two groups, namely, image group 402 and image group 404.

The image group 402 includes images 406, 408, 410 and 412. The aforementioned group of images is adapted to illustrate the bright shape across the scenery 250 shown in FIG. 3B when the laser 262 projects the beam of light in the upper portion of the scenery as achieved, for example, by the plane 268, 278. Similarly, the image group 404 includes images 414, 416, 418 and 420, illustrating images of the bright shape produced by the laser planes 266, 278, on the lower portion of the scenery 250. Hence, the collection of images shown in groups 402 and 404 are in accordance with the two modulations having a first and second frequency attributed with the rotational and translational, respectively, motions of the light source 262.

As illustrated by FIG. 4, the scenery 208/250 is made up of a background, i.e., 204, and a grid, i.e., 206 shown in FIGS. 2 and 3A. As depicted by FIG. 4, the light lines resulting from the projection of the laser beam across the background is labeled by reference numeral 422, while the circular spots resulting from the projection of the laser beam across the grid is labeled by reference numeral 424.

Referring again to image group 402, particularly to the images 406, 410 and 412, it is shown that in those images no alignment exists between the laser line 422 and laser spots 424. Because of such misalignment between the lines 422 and spots 424, it follows that in image frames 406, 410, and 412 both the laser beam and the focal point 212 of the camera shown, for example, in FIGS. 3A and 3B, are not situated on a single mutual spatial plane. Similarly, images 414, 418, 420 of the image group 404, display the laser line 422 and spots 424 across the background and grid, respectively, as being off-set relative to one another indicating, as well, that in those image frames both the laser beam and the focal point of the camera are not exactly disposed on the same spatial plane.

In contrast, images 408 and 416 of the images groups 402 and 404, respectively, show both the laser line 422 of the background 204 aligning exactly with the laser spots 424 across the grid 406, thereby indicating that both the laser beam and the focal point are situated on the same spatial plane. Those skilled in the art will appreciate that because of the alignment featured by the laser spots and lines across the grid and background, respectively, the images 408 and 416 provide optimal images from which information relating to distortions of a camera, such as those produced by the lens 208 of FIGS. 3A and 3B, can be obtained. Thus, the images 408 and 416 may be selected from the plurality of images 406-420 for better yet defining the optical distortions produced by the lens 208 shown in FIGS. 3A and 3B.

Furthermore, images such as those illustrated by FIG. 4 may be obtained by a user, or those could be acquired by automated process over prolonged durations for generating multiple images of the laser as it is being projected across the background and the grid at various angles and orientations. While such undertaking may produce multiple images in which the alignment between the laser spots and lines may not be perfect, the user and/or automated process may nevertheless benefit from having a large collection of images from which to select a subset of images having the desirable alignment between the lines and spots, as exemplified by images 408 and 416. This may further enhance the quality of information related the distortions produced by the lens and, thus, may overall improve the characterization of the optical system.

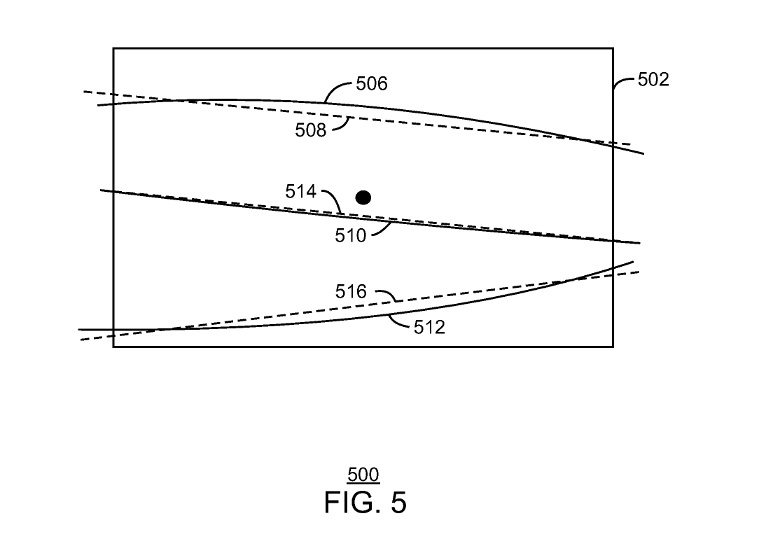

FIG. 5 shows an image 500 resulting from collection of images superimposed one on top of another, in accordance with the present invention. The image 500 is obtained from the collection of multiple stacked images, such as the selected images 408 and 416, showing the laser lines across the background as being coincident with the laser spots across the grind. Hence, the collection of images forming the final image 500 may be obtained by methods and systems similar to those discussed above. Further, the object of forming a single image from a superposition of selected images is to better accentuate and amplify optical distortions produced by the optical system.

Accordingly, FIG. 5 shows an image 502 with an image center 504. In its upper portion, the image 502 depicts a laser line 506 disposed above the center 504. Again, it should be borne in mind that the image of the laser line 506 may be result of not one, but multiple superimposed laser lines, each of which may originate from a single selected image where a laser line is coincident with a laser spot projected across a background and grid, respectively. The laser line 506 extends across the entire length of the image 502 and, in so doing, exhibits a certain degree of curvature as compared to a straight line 508 extending across the image 502 as well. Hence, the amount of curvature existing between the lines 506 and 508 can be utilized as a measure for determining and/or quantifying the amount distortions attributable to the lenses of the camera. Furthermore, the quantification of such lens distortion information, as obtained from the line 506, can further be utilized for ultimately adjusting and/or for calibrating the optical system. Such information can also be used for image correction and/or enhancement in post processing.

By further example, the image 502 also includes image lines 510 and 512, both of which are disposed below the center 504. The lines 510 and 512 are accompanied by straight lines 514 and 516, respectively, for comparison. As illustrated, out of the three laser lines 506, 510 and 512, the bottom laser line 512 appears to have the most significant amount of curvature when compared to the straight line 516. By contrast, the middle line 510 appears to have the least amount of distortion as compared to the straight line 514. Hence, the varying amount of curvature of each of the above lines may exemplify the varying amount of lens distortions produced across the filed of view of the optical system. Hence, the image 502 and the resulting lines 506, 510 and 512 contained therein may form a two dimensional map from which information can be used for typifying the optical system, as well as for correcting images derived therefrom.

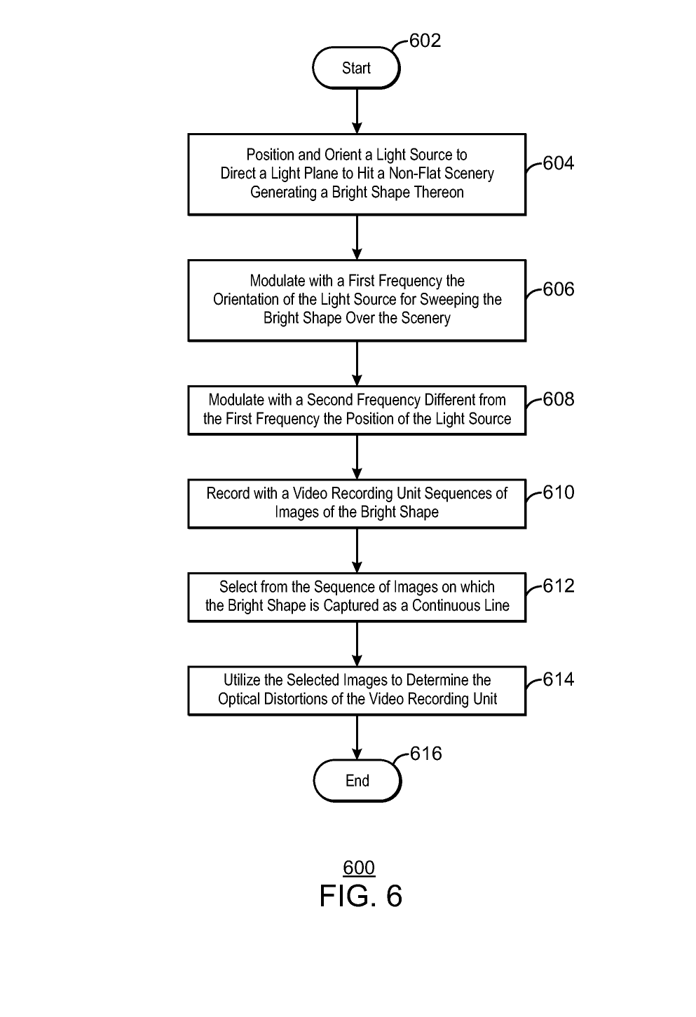

FIG. 6 is a block diagram 600 of a process flow, in accordance with the present invention. Accordingly, the block diagram 600 provides a method for determining optical distortions in an optical recoding unit, such as those discusses above with reference to FIGS. 2-5. The disclosed optical system may generally include a camera, i.e., a lens and a CCD, a grid and a background, all of which can be used for obtaining images, such as those of depicting a laser projected across the grid and background. Further, the method may be implemented by employing some or all of the elements described above or equivalents thereof.

The block diagram 600 begins at block 602 from which the process flow advances to block 604. At block 604, a light source is positioned and oriented such that it directs a light plane to hit a non-flat scenery generating a bright shape thereon. As discussed above, the method 600 may employ scenery that includes a grid positioned in front of a background or, stated otherwise, the grid may be positioned between the background and a lens of the optical system.

From bock 604, the method 600 proceeds to block 606 where the orientation of the light source is modulated with a first frequency, such that the bright shape formed on the scenery periodically sweeps over a scenery in a sweeping direction non-parallel to a direction of main extension of the bright shape. In a preferred embodiment, as the light source projects the light plane across the background and grid, the laser rotates and/or translates about axes, disposed generally transverse to the optical axis of the camera. Next, the process flow 600 proceeds to block 608 where the position of the light source is modulated with a second frequency, different from the first frequency, where the positioning of the light source is made relative to the video recording unit in a sweeping motion. Here, too, in projecting the light plane, the light source may rotate and/or translate about axes, disposed generally transverse to the optical axis of the camera.

From block 608 the process flow advances to block 610 where a video recording unit records sequences of images capturing at least parts of the bright shape while the orientation and position of the light source are being modulated. Next, at block 612, the process flow selects from the sequences of images those images as selected images in which the bright shape is captured as a continuous line. More specifically, the selection of images, as done at block 612, is premised on requiring those images to satisfy certain criteria. One such criterion, for example, may require the lines projected across the background coincide with the spots projected across the grid. Accordingly, by satisfying the above criterion the selected images may provide additional information one or more optical distortions produced by the optical system. Further, at block 614, the selected images of block 612 are utilized to determine the optical distortions of the video recording unit. This may involved additional image analysis, such as combining and/or superimposing the images to form a single image for amplifying lens distortions appearing in the field of view of the optical system. As discussed above, the general method, as carried out by the process flow 600, may provide desired lens distortion parameters ultimately used for typifying the optical system at hand. Finally, the process flow ends at block 616.

One of ordinary skill will appreciate that combining any of the above-recited features of the present invention together may be desirable.

1. A method for determining optical distortions of a video recording unit, comprising:
positioning and orienting a light source such that it directs a light plane to hit a non-flat scenery generating a bright shape thereon;
modulating, with a first frequency, the orientation of the light source, such that the bright shape periodically sweeps over the scenery in a sweeping direction non-parallel to a direction of main extension of the bright shape;
modulating, with a second frequency different from the first frequency, the position of the light source relative to the video recording unit in the sweeping direction;
recording, with the video recording unit and while the orientation and the position of the light source are being modulated, sequences of images capturing at least parts of the bright shape;
selecting, from the sequences of images, those images as selected images in which the bright shape is captured as a continuous line; and
utilizing the selected images to determine the optical distortions of the video recording unit.

2. A method according to claim 1, wherein the scenery comprises a grid being positioned in front of a background, and wherein the bright shape comprises bright spots on the grid and a bright curve on the background.

3. A method according to claim 2, wherein the step of selecting images is constituted by selecting images in which the bright spots are captured as coinciding with the bright curve.

4. A method according to claim 1, wherein the step of utilizing comprises overlaying the continuous lines captured in two or more of the selected images into a single image, and evaluating the single image.

5. A system for determining optical distortions of a video recording unit, comprising:
a light source, arranged at a first distance from a non-flat scenery, and generating a light plane hitting the scenery and generating a bright shape thereon;
a video recording unit, arranged at a second distance from the scenery different from the first distance, and capturing the scenery and at least part of the bright shape;
means for modulating, with a first frequency, the orientation of the light source such that the bright shape periodically sweeps over the scenery in a sweeping direction non-parallel to a direction of main extension of the bright shape;
means for modulating, with a second frequency different from the first frequency, the position of the light source relative to the video recording unit in the sweeping direction;
the video recording unit being equipped and configured to record, while the orientation and the position of the light source are being modulated, sequences of images capturing at least parts of the bright shape; and
the system being equipped and configured to utilize, for the determining of optical distortions, those of the images where the bright shape is captured as a continuous line.

6. A system according to claim 5, additionally comprising means for selecting, from the sequences of images, those images as selected images in which the bright shape is captured as a continuous line.

7. A system according to claim 6, wherein the scenery comprises a grid positioned in front of a background, and wherein the bright shape comprises bright spots on the grid and a bright curve on the background.

8. A system according to claim 7, wherein the means for selecting are equipped and configured to select those images in which the bright spots are captured as coinciding with the bright curve.
